(19) United States
(12) Patent Application Publication
(10) Pub. No.: US 2001/0022273 A1
(43) Pub. Date: Sep. 20, 2001

(54) Electrochemical treatment of water and aqueous salt solutions

(75) Inventors: Alexey Yurievich Popov, Moscow (RU); Dmitriy Alekseyvich Popov, Moscow (RU)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Sterilox Medical (Europe) Limited

(21) Appl. No.: 09/752,386

(22) Filed: Dec. 29, 2000

Related U.S. Application Data
(63) Continuation of application No. PCT/GB99/02054, filed on Jun. 30, 1999.

(30) Foreign Application Priority Data
Jun. 30, 1998 (RU) RU 98113092

(51) Int. Cl. B01D 61/42; B01D 69/06

(52) U.S. Cl. 204/518; 204/627

(57) ABSTRACT

A relatively concentrated and a relatively dilute aqueous salt solution are respectively passed through the anode and cathode chambers of a flow-through electrochemical cell having a porous membrane separating the two chambers. The fluid pressure in the cathode chamber is maintained at less than atmospheric pressure and at less than the fluid pressure in the anode chamber while a potential difference is applied across the anode and cathode. In this way, dangerous build-up of gaseous electrolysis products in the chambers, especially the anode chamber, is avoided.

### CROSS-REFERENCE TO RELATED APPLICATION

This application is a continuation of International Application No. PCT/GB99/02054 filed, Jun. 30, 1999, the disclosure of which is incorporated herein by reference.

### BACKGROUND OF THE INVENTION

The present invention relates to the electrochemical treatment of water and aqueous solutions of salt with the aim of altering the oxidizing and reducing properties of the water or the aqueous solutions of salt. Such electrochemical treatment may take the form of anodic treatment for obtaining disinfectant solutions, cathodic water-softening treatment, or other treatments.

It is known from GB 2 253 860, the disclosure of which is incorporated into the present application by reference, to treat water by passing this through an electrolytic cell having anode and cathode flow chambers separated by a semi-permeable membrane, one of the chambers being a working chamber through which water to be treated passes in an upward direction, and the other being an auxiliary chamber, which is in closed communication with a gas-separating chamber located at a higher level than the electrolytic cell. The electrolytic cell comprises a tubular outer electrode and a rod-shaped inner electrode, the two electrodes being concentric and separated by the semi-permeable membrane so as to define the working and auxiliary chambers. Notwithstanding the semi-permeable membrane, the working and auxiliary chambers are hermetically sealed from each other by way of elastic separator collars, and each has entry apertures in the lower part and exit apertures in the higher part. Water having a higher mineral content than the water to be treated passes upwardly through the auxiliary chamber to the gas-separating chamber and recirculates to the auxiliary chamber by convection and by the shearing forces applied to the water through the rise of bubbles of gas which are generated on the electrode in the auxiliary chamber. In this way, the auxiliary solution circulates around a closed contour. The water pressure in the working chamber is higher than that in the auxiliary chamber, and gaseous electrolysis products are vented from the gas-separating chamber by way of a gas-relief valve. Some of the working solution will tend to pass from the working chamber to the auxiliary chamber across the semi-permeable membrane by virtue of the pressure gradient between the working and auxiliary chambers. Surplus auxiliary solution may be removed by way of the gas-relief valve or from the gas-separating chamber.

This method allows the pH value of the water being treated to be reduced from 7 to around 2, when the anode chamber is used as the working chamber. If instead the cathode chamber is used as the working chamber, the pH value of the water to be treated can be increased to around 12. This known method of electrolytic treatment is applied only to water having a relatively low concentration of dissolved salts and minerals (less than 10 gdm⁻³), and the electricity supplied for the electrolytic treatment of water in the working chamber is only around 200 to 3000 Cdm⁻³. Because the water to be treated has such a low concentration of dissolved salts and minerals, there is consequently a low concentration of useful electrolysis products (such as the chlorate (I) ion CIO⁻) which is produced when a sodium chloride solution is used in the auxiliary chamber and which acts as a disinfecting agent). In addition, water with a low concentration of salts and minerals tends to have a high ohmic resistance, which means that energy is used inefficiently when performing electrolysis. Furthermore, the small amount of electricity (200 to 3000 Cdm⁻³) applied to the water in the working chamber is insufficient to ensure the full transformation of the ions of dissolved salts (such as chloride ions Cl⁻) into useful electrolysis products (such as chlorate (I) ions ClO⁻). The incomplete electrolysis of dissolved salts means that a greater than theoretically necessary amount of salt must initially be dissolved in order to provide a required concentration of electrolysis products. This excess of dissolved salt can mean that the output of the electrolytic cell is overly corrosive, and when used as a disinfectant wash, tends to leave a coating of crystalline salt on surfaces which have been washed. A further disadvantage of the known procedure is that there is no possibility of producing anodically treated water having a pH greater than 7, for example, in order to reduce the corrosion activity of the water. A single pass of weakly mineralized water through the working chamber results in only an insignificant proportion of the dissolved salts being transferred into the products of the electrochemical reactions.

It is known from RU 2110483 to provide an electrolytic cell in which an aqueous salt solution of high concentration is pumped under excess pressure into the anode chamber. The solution output from the anode chamber having oxidizing properties is produced only with a pH of less than 7.0, and is therefore corrosive. Furthermore, the excess pressure in the cell reduces operating reliability, and there is an inefficient dissolution of salts in the water which requires enforced circulation of the anolyte to provide more effective operation, which can be technically difficult to achieve.

It is useful to consider the basic chemical reactions which take place in the anode and cathode chambers of the electrolytic cell. If the working chamber contains the anode, then the following reactions take place:

Chloride ions transform into gaseous chlorine at the anode in accordance with the following equation:

2Cl⁻→Cl₂+2e⁻

Gaseous chlorine dissolves in water and forms hypochlorous acid in accordance with the following equation:

Cl₂+H₂O→H⁺+Cl⁻+HClO

Electrolysis of water also takes place in the anode chamber. The equation is as follows:

2H₂O→4H⁺+O₂+4e⁻

As a result of this reaction, gaseous oxygen is liberated and the water becomes saturated with hydrogen ions. Consequently, the pH of the water falls in the anode chamber. The solubility of chlorine in the water reduces as the pH is lowered, and gaseous chlorine is liberated with oxygen.

Electrolysis of water takes place in the cathode chamber. The equation is as follows:

2H₂O+2e⁻→2OH⁻+H₂

Consequently gaseous hydrogen is liberated at the cathode, and the concentration of hydroxide ions rises, thereby increasing the water pH in the cathode chamber.

It follows from this analysis that the oxidizing ability of water is determined by the concentration of hypochlorous acid, and the reduction ability by the concentration of hydroxide ions. Water which has been under electrolytic treatment according to the method described in GB 2253860 has a low concentration of hypochlorous acid and hydroxide ions due to the low mineralization of the initial water.

One way of estimating the effectiveness of a sterilizing solution produced by the electrolytic treatment of a salt solution is to measure the concentration of “free chlorine”, by which is understood the concentration of hypochlorous acid in water and the concentration of the chlorate ion (formed by the dissociation of hypochlorous acid).

The concentration of free chlorine in water which has been treated in the anode chamber of the electrolytic cell of GB 2253860 does not usually exceed 0.2 to 0.6 gdm⁻³, although the solubility of gaseous chlorine in water is much higher (7.3 gdm⁻³ at 20° C.). It is therefore apparent that water which has been under electrolytic treatment in accordance with the known method has a concentration of free chlorine not more than 3 to 10% of the possible maximum. This low concentration is a result of the fact that only a small proportion of the chloride ions which are drawn across the permeable membrane from the cathode flow chamber to the anode flow chamber actually reach the anode to be combined so as to form gaseous chlorine. Most of the chloride ions in the anode chamber are carried out of the electrolytic cell with the output of the anode flow chamber before reaching the anode itself.

### SUMMARY OF THE INVENTION

According to a first aspect of the present invention, there is provided a method of treating aqueous salt solutions in an electrolytic cell, the cell comprising a working chamber and an auxiliary chamber separated from each other by a permeable membrane, one chamber including an anode and the other a cathode, wherein:

i) a relatively concentrated aqueous salt solution is supplied to the working chamber at a first given pressure;

ii) a relatively dilute aqueous salt solution is supplied to the auxiliary chamber at a second given pressure; and

iii) an electric current is applied between the anode and the cathode through the aqueous salt solutions and the permeable membrane so as to cause electrolysis of the aqueous salt solutions; characterized in that the pressure of the aqueous salt solution in the auxiliary chamber is maintained at less than ambient atmospheric pressure and less than the pressure of the aqueous salt solution in the working chamber.

According to a second aspect of the present invention, there is provided an apparatus for the electrolytic treatment of aqueous salt solutions, the apparatus comprising an electrolytic cell having a working chamber and an auxiliary chamber separated by a permeable membrane, each chamber having a respective input line and output line, one chamber including an anode and the other a cathode, and a supply of a relatively concentrated and a supply of a relatively dilute aqueous salt solution, said supplies being connected respectively to the input lines of the working and the auxiliary chambers, wherein the supply of relatively concentrated aqueous salt solution is adapted to provide a first fluid pressure in the working chamber and the supply of relatively dilute aqueous salt solution is adapted to provide a second fluid pressure in the auxiliary chamber; characterized in that the second fluid pressure is less than the first fluid pressure and also less than ambient atmospheric pressure.

According to a third aspect of the present invention, the procedure for the electrochemical treatment of water is characterized in that the original water, which contains dissolved salts, is supplied to the space between the anode and a porous diaphragm for electrochemical treatment in the anode chamber of a diaphragm electrolyser. At the same time, weakly mineralized water is supplied to the cathode chamber, and passes from below to above through the space between the anode and the cathode, acquires reducing properties and leaves the cathode chamber in its upper section, such that between the anode and cathode chambers, a pressure drop is generated which produces a filtration stream of liquid from the anode chamber to the cathode chamber. Moreover, an electric current passes between the anode and the cathode through the water in both chambers and the porous diaphragm which separates these chambers. The novelty of the procedure is that the original water, which has a high concentration of dissolved salts in the 2-35 per cent range, is supplied to the anode chamber, and in that weakly mineralized water having a dissolved salts concentration of not more than 0.2 per cent, is supplied to the cathode chamber. The pressure drop thus generated between the anode and cathode chambers results in the water in the anode chamber being at atmospheric pressure, and under a vacuum of 0.02-0.09 MPa in the cathode chamber. Moreover, the electrolysis gases which are formed in the anode chamber, are removed from it in its upper section and dissolved in the entire volume or in a portion of the water undergoing cathodic treatment, and is then mixed with the weakly mineralized water that is not electrochemically treated, thus imparting oxidizing properties to this water volume or portion thereof.

According to a fourth aspect of the present invention, a device for the electrochemical treatment of water comprises at least one flow-through diaphragm electrolyser in the form of anode and cathode chambers which are separated by a porous diaphragm and equipped with separate inlet and outlet branch pipes and a circulation loop formed by a pipeline connected to the outlet and inlet branch pipes of the anode chamber, and connected by a pipeline to the suction branch pipe of a water jet pump that provides water having oxidizing properties. The novelty of the device is that the inlet branch pipe of the anode chamber is connected by a pipeline to a vessel for storing highly mineralized water, and in that the circulation loop is connected to the atmosphere via a pipeline having a non-return valve. Moreover, the inlet branch pipe of the cathode chamber is connected by a pipeline which is equipped with a flow controller to the weakly mineralized water pipeline, and the outlet branch pipe of the cathode chamber is connected to the suction branch pipe of the water jet pump which provides water having oxidizing properties. Under these conditions, the inlet branch pipe of the water jet pump is connected by a pipeline to the weakly mineralized water pipeline, and the outlet branch pipe is connected to the vessel for storing water having reducing properties. The latter vessel is connected to the suction branch pipe of the centrifugal pump which supplies alkaline water, and the outlet branch pipe of this pump is connected via a pipeline to the inlet branch pipe of the water jet pump that supplies water having oxidizing properties, and the outlet branch pipe of the water jet pump is connected to the vessel for storing water having oxidizing properties.

Advantageously, the centrifugal pump is equipped with a bypass pipeline having a flow controller.

### BRIEF DESCRIPTION OF THE DRAWING

The foregoing summary, as well as the followed detailed description of the invention, will be better understood when read in connection with the appended drawing. For the purpose of illustrating the invention, there is shown in the drawing one embodiment of the invention. It should be understood, however, that the invention is not limited to the precise arrangements and instrumentalities shown. In the drawing;

FIG. 1 is a schematic flow diagram of a device for the electrochemical treatment of water according to the present invention.

### DETAILED DESCRIPTION OF THE INVENTION

In a preferred embodiment, the working chamber includes the anode and the auxiliary chamber the cathode. The following description refers to this embodiment, although it will be appreciated by a person of ordinary skill that the anode and cathode may be reversed for certain applications.

Salts suitable for making up the aqueous salt solutions include sodium chloride, potassium chloride, lithium chloride and any combination thereof.

The present invention allows the corrosion activity of the water having oxidizing properties to be reduced by increasing its pH, and achieving increased efficiency in the use of chemical reagents (salts) dissolved in the water.

The relatively concentrated aqueous salt solution, which typically has a salt concentration of 2 to 35 per cent, is supplied to the working chamber which includes an anode. The relatively dilute aqueous salt solution, which typically has a salt concentration of up to 0.2 per cent, is supplied to the auxiliary chamber which includes a cathode, such that an electrical current is passed between the anode and the cathode through the water in both chambers and the porous diaphragm that separates the chambers. Compared with the prior art, the present invention provides for maintaining a pressure below that of the atmosphere (typically 0.02-0.09 MPa) in the auxiliary chamber, such that due to the vacuum, the catholyte and the hydrogen generated in the cathode chamber during electrolysis are removed from the cathode chamber, and may be mixed with non-electrochemically treated relatively dilute aqueous salt solution so as to yield alkaline water having reducing properties. Moreover, the electrolysis gases which are generated in the anode chamber are removed therefrom and may be dissolved in the aforementioned alkaline water using the entire volume or only a portion thereof. In preferred embodiments, the pressure in the working chamber is maintained at slightly below ambient atmospheric pressure, but higher than the pressure in the auxiliary chamber. This means that generation of electrolysis gases such as chlorine in the working chamber does not cause dangerous increases in pressure with the associated risk of explosion or leakage to atmosphere.

The electrolytic cell of the present invention comprises anode and cathode chambers that are separated by a porous diaphragm and which may be equipped with separate inlet and outlet lines. The anode chamber preferably includes a circulation loop that is formed by a pipeline that connects the outlet and inlet lines of the anode chamber, this circulation loop also being connected by a pipeline to an input of a gas/liquid mixing device, e.g. the suction line of a water jet pump or venturi, which supplies treated solution having oxidizing properties, this being effected by dissolving gaseous electrolysis products from the anode chamber in the solution output from the cathode chamber. The inlet line of the anode chamber is connected by a pipeline to a supply of relatively concentrated aqueous salt solution, and the circulation loop may be connected to the atmosphere via a pipeline equipped with a non-return valve. Moreover, the inlet line of the cathode chamber is connected by a pipeline that may be equipped with a flow controller to the supply of relatively dilute aqueous salt solution, and the outlet line of the cathode chamber may be connected to an input of a liquid mixing device, e.g., the suction pipeline of a water jet pump or venturi, that supplies treated solution having reducing properties. Under these conditions, the inlet line of the water jet pump is connected via a pipeline to the supply of relatively dilute aqueous salt solution, and the outlet line is connected to a vessel for storing treated solution having reducing properties. The latter vessel may be connected to the suction pipeline of a pump, e.g., a centrifugal pump, for supplying alkaline solution, and the outlet line of the pump may be connected by a pipeline to the inlet line of the gas/liquid mixing device that supplies solution having oxidizing properties. Moreover, the outlet line of the gas/liquid mixing device is connected to a vessel for storing solution having oxidizing properties. Under these conditions, the pump may be equipped with a bypass pipeline having a flow controller.

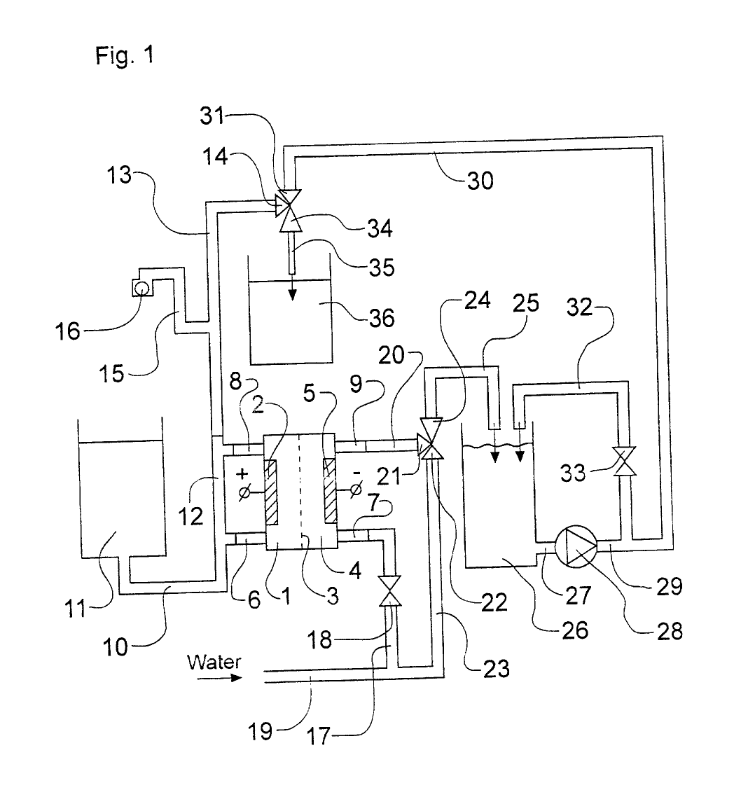

For a better understanding of the present invention, and to show how it may be carried into effect, reference will now be made by way of example to the accompanying FIG. 1, which shows the anode chamber 1 formed by the anode 2 and the semi-permeable diaphragm 3, and the cathode chamber 4 formed by the cathode 5 and the diaphragm 3. The device also contains the inlet lines 6 and 7 and the outlet lines 8 and 9 of the anode and cathode chambers respectively. The inlet line 6 of the anode chamber is connected by the pipeline 10 to the highly mineralized water vessel 11. The outlet line 8 of the anode chamber 1 is connected to the inlet line 6 by the pipeline 12 to form the anode chamber circulation loop. Moreover, the outlet line 8 of the anode chamber is connected by the pipeline 13 to the suction line 14 of the water jet pump that supplies water having oxidizing properties. The pipeline 13 is connected to the atmosphere via pipeline 15 equipped with a non-return valve 16. The inlet line 7 of the cathode chamber 4 is connected by the pipeline 17 which is equipped with a flow controller 18 and to the weakly mineralized water pipeline 19. The outlet line 9 of the cathode chamber is connected by the pipeline 20 to the suction line 21 of the water jet pump that supplies water having reducing properties (alkaline water). The inlet line 22 of the water jet pump is connected via the pipeline 23 to the weakly mineralized water pipeline 19, and the outlet line 24 is connected by the pipeline 25 to the alkaline water vessel 26. This latter vessel is connected at its lower section to the suction line 27 of the centrifugal pump 28. The outlet line 29 of the centrifugal pump 28 is connected by pipeline 30 to the inlet line 31 of the water jet pump that supplies water having oxidizing properties. The outlet line 29 of the centrifugal pump 28 may be connected by the bypass pipeline 32 which is equipped with a water flow controller 33 to the alkaline water vessel 26. The outlet line 34 of the water jet pump which supplies water having oxidizing properties, is connected via the pipeline 35 to the vessel 36.

The vessel 11 is filled with highly mineralized water in the form of a 2-35 per cent solution of sodium chloride so that its level is equal to or above that of the outlet line 8 of the anode chamber 1 of the electrolyser. Highly mineralized water from the vessel 11 passes along the pipeline 10 through the inlet line 6 and fills the anode chamber 1 and its circulation loop which is formed by the inlet 6 and outlet 8 lines, and the pipeline 12. The weakly mineralized water is supplied under a pressure of 0.2-0.7 MPa to the pipeline 19 from which it passes along pipeline 17, through the flow controller 18 and the inlet line 7 into the cathode chamber 4 of the electrolyser. At the same time, weakly mineralized water is passed along pipeline 23 to the inlet line of the water jet pump to supply water having oxidizing properties, thus creating a vacuum in the cathode chamber 4. A voltage from a direct current source that is not shown in FIG. 1, is applied to the anode 2 and the cathode 5. Between the anode 2 and the cathode 5, an electrical circuit is made through the water that fills the anode chamber 1, the cathode chamber 4 and the porous diaphragm 3, thus generating an electrical current. Due to this electrical current, the water that contains dissolved salts is electrochemically treated by electrolysis. As a result of this electrolysis, the weakly mineralized water that enters the cathode chamber 4, acquires reducing properties at a pH of 10-12 and a redox potential of -500 to -700 mV. The cathodically treated water or catholyte, together with the hydrogen generated at the cathode during electrolysis, is drawn off from the cathode chamber 4 via the outlet line 9, the pipeline 20 and the suction line 21 in the water jet pump, where the water is mixed with the weakly mineralized water and is then transferred through the outlet line 24 and along the pipeline into the vessel 26. As a result, water having reducing properties (a redox potential of −400 to −600 mV as measured with a silver chloride reference electrode and a pH of 9-11) accumulates in vessel 26. During electrolysis of the sodium chloride solution in the anode chamber 1, chlorine and oxygen are liberated at the anode 2. The gas bubbles rise to the upper section of the anode chamber 1, and via the outlet line 8, leave the electrolyser and enter the pipeline 13. Due to the movement of the electrolysis gas bubbles, a vacuum or gas-lift effect is generated in the lower section of the anode chamber 1, such that this promotes circulation of the anodically treated water (anolyte) around the circulation loop formed by the anode chamber 1, the outlet line 8, the pipeline 12 and the inlet line 6. Due to the presence of the centrifugal pump 28, alkaline water from the vessel 26 passes under a pressure of 0.2-0.5 MPa along the pipeline 30 into the inlet line 31 of the water jet pump that supplies water having oxidizing properties. The electrolysis gases that are generated in the anode chamber, are drawn off by the water jet pump along the pipeline 13 via the suction line 14. The chlorine and oxygen electrolysis gases are dissolved in the alkaline water in the water jet pump, thus establishing oxidizing properties. This water enters the pipeline 35 into the vessel 36 via the outlet line 34 of the water jet pump. In order to avoid the anolyte from the circulation loop being entrapped in the water having oxidizing properties and accumulating in the vessel 36, the pipeline 13 is connected to the atmosphere via the pipeline 15 which is equipped with the non-return valve 16. The latter prevents penetration of the chlorine into the atmosphere from the pipeline 13 due to the absence of a vacuum in the suction line 14, for example, during accidental disconnection of the pump 28. In order to control the use of alkaline water, the pump 28 may be equipped with a bypass pipeline 32 having a flow controller 33.

The vacuum generated in the cathode chamber 4 provides for, on one hand, an increased rate of hydrogen removal from the cathode chamber 4, and on the other, an increased rate of gaseous chlorine removal from the anode chamber 1. The latter effect may be accounted for by the fact that due to the pressure drop between the anode 1 and the cathode 4 chambers (in the anode chamber, the pressure is equal to that of the atmosphere, and in the cathode chamber, it is lower than that of the atmosphere), an anolyte filtration stream exists from the anode chamber 1 through the porous diaphragm 3 into the cathode chamber 4. As a result of this stream, the rate of electromigratory transfer of hydroxyl ions (OH) from the cathode chamber 4 into the anode chamber 1 is reduced, which, in turn, prevents an increase in the anolyte pH. The solubility of chlorine is reduced in an acidic anolyte (pH about 4) thus increasing its volatility, and as a result, increasing the current yield efficiency. The use of alkaline water to dissolve the electrolysis gases that are generated in the anode chamber enables water having oxidizing properties to be produced, such that the pH is in the neutral and weakly alkaline ranges (for example, 6.8-8.2). Moreover, chlorine is more easily soluble in alkaline water than in neutral water, which increases its efficient use for the production of water having oxidizing properties. The supply of weakly mineralized water containing less than 0.2 per cent of dissolved salts to the cathode chamber, enables water having oxidizing and reducing properties and a low level of residual mineralization to be produced. The production of water having oxidizing properties by dissolving electrolysis gases (chlorine) in weakly mineralized alkaline water enables disinfecting solutions having a reduced corrosion activity to be prepared, due to the increased pH relative to a standard procedure.

Electrochemical treatment of water was carried out using the claimed and a known procedure. The treatment was carried out in a flow-through cylindrical diaphragm electrolyser. The diaphragm was a porous oxide ceramic tube based on aluminium oxide with additions of zirconium and ruthenium oxides. The tube thickness was 1 mm, the length was 210 mm, and the filtration surface was 70 square centimeters. The permanent anode was a titanium tube having an internal surface coating of ruthenium oxide. The cathode was a titanium rod, and was positioned coaxially inside the tubular ceramic diaphragm, and the latter was also positioned coaxially within the tubular anode. The anode and cathode chambers were separated with rubber sealing rings. The anode was assembled with the cathode and the diaphragm, and placed in plastic sleeves fitted with inlet and outlet sleeves for the anode and cathode chambers, and attached in the anode and cathode chambers with nuts and washers. The anode and the cathode were connected by electrical leads to the positive and negative terminals of a stabilized direct current source, respectively. The highly mineralized water was a saturated aqueous solution of sodium chloride at a concentration of 300 grams per cubic decimeter. Water having oxidizing properties was obtained by dissolving chlorine that was generated in the anode chamber during electrolysis, in alkaline water. Mixing the chlorine and the alkaline water was carried out with a water jet pump used for preparing water having oxidizing properties. An addition of mains water was made to the cathode chamber, and the consumption was regulated with a flow controller (valve) located on the tube connecting the mains water pipeline and the inlet line of the cathode chamber. The outlet line of the cathode chamber was connected to the suction line of the water jet pump used to prepare water having reducing properties. Mains water at a pressure of 0.3 MPa was added to the water having reducing properties. The catholyte, which was produced in the cathode chamber during electrolysis, was removed by the water jet pump due to the vacuum of 0.06 MPa and mixed with the mains water to produce alkaline water having a pH of 10.8 and which accumulated in the vessel for the alkaline water, that is, the water having reducing properties. Alkaline water was removed from the vessel by the centrifugal pump, and was supplied at a pressure of 0.25 MPa to the water jet pump that was used to produce water having oxidizing properties. This pump was used to remove chlorine from the circulation loop of the anode chamber and dissolve it in the alkaline water to yield water having oxidizing properties.

The results obtained from the electrochemical treatment are presented in Table 1.

TABLE 1

| Index | Claimed Procedure | Standard Procedure |
|---|---|---|
| NaCl salt content of anode | 300 | 300 |
| chamber water, g per liter | | |
| Voltage, V | 4 | 4 |
| Current, A | 10 | 10 |
| Oxidizing water pH | 7.6 | 4.8 |
| Active chlorine content in | 250 | 250 |
| oxidizing water, mg per liter | | |
| Oxidizing water minerali- | 860 | 920 |
| zation, mg per liter | | |
| Oxidizing water output, liters | 30 | 30 |
| per hour | | |
| Salt demand, g per liter of | 0.6 | 2.3 |
| oxidizing water | | |

As may be seen from Table 1, the claimed technical solution has a number of advantages over the standard procedure, and these are:

a) The pH value of the oxidizing water is higher, which indicates a lower corrosion activity index for the water produced by the claimed procedure.

b) The salt demand (sodium chloride) is about a fourfold factor lower than for the standard method.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of treating aqueous salt solutions in an electrolytic cell, the cell comprising a working chamber and an auxiliary chamber separated from each other by a permeable membrane, the working chamber including an anode and the auxiliary chamber including a cathode, the method comprising:
i) supplying a relatively concentrated aqueous salt solution having a salt concentration of 2 to 35% to the working chamber at a first given pressure;
ii) supplying a relatively dilute aqueous salt solution having a concentration of up to 0.2% to the auxiliary chamber at a second given pressure;
iii) applying an electric current between the anode and the cathode through the aqueous salt solutions and the permeable membrane so as to cause electrolysis of the aqueous salt solutions;
iv) maintaining the pressure of the aqueous salt solution in the auxiliary chamber at less than ambient atmospheric pressure and less than the pressure of the aqueous salt solution in the working chamber; and
v) removing gaseous products of electrolysis in the working chamber therefrom and dissolving them in solution output from the auxiliary chamber.

2. The method according to claim 1, wherein the pressure of the aqueous salt solution in the auxiliary chamber is 0.02 to 0.09 Mpa.

3. The method according to claim 1, wherein gaseous products of electrolysis in the working chamber are removed therefrom and dissolved in a mixture of the relatively dilute aqueous salt solution and solution output from the auxiliary chamber.

4. An apparatus for the electrolytic treatment of aqueous salt solutions, the apparatus comprising an electrolytic cell having a working chamber and an auxiliary chamber separated by a permeable membrane, the working chamber including an anode and the auxiliary chamber including a cathode and each chamber having a respective input line and output line; the output line of the auxiliary chamber being connected to a first input of a mixing device and the output line of the working chamber being connected to the input line of the working chamber so as to provide a recirculation loop, said recirculation loop being open to the atmosphere by way of a line having a non-return valve and said recirculation loop also being connected to a first input of a gas/liquid mixing device; a supply of a relatively concentrated and a supply of a relatively dilute aqueous salt solution, said supplies being connected respectively to the input lines of the working and the auxiliary chambers; the supply of relatively dilute aqueous salt solution also being connected to a second input of the said mixing device; and an output of the said mixing device being connected to a second input of the said gas/liquid mixing device, wherein the supply of relatively concentrated aqueous salt solution is adapted to provide a first fluid pressure in the working chamber and the supply of relatively dilute aqueous salt solution is adapted to provide a second fluid pressure in the auxiliary chamber, characterized in that the second fluid pressure is less than the first fluid pressure and also less than ambient atmospheric pressure.

5. The apparatus as claimed in claim 4, wherein the said connection between the mixing device and the gas/liquid mixing device is made by way of a liquid storage vessel and a pump.

6. The apparatus as claimed in claim 4, wherein the pump is provided with a bypass line including a flow controller.
